(19) United States
(12) Patent Application Publication
(10) Pub. No.: US 2010/0086301 A1
(43) Pub. Date: Apr. 8, 2010

(54) DIRECTIONLESS RECONFIGURABLE OPTICAL ADD/DROP MULTIPLEXER

(76) Inventors: Junichiro FUJITA, Cambridge, MA (US); Reinald Gerhardt, Wakefield, MA (US); Fang Wang, Acton, MA (US); Jiandong Shi, Methuen, MA (US)

Correspondence Address: Kieun "Jenny" Sung;Innovation Counsel LLP, Suite 200, 21771 Stevens Creek Boulevard, Cupertino, CA, 95014, US

(21) Appl. No.: 12/573,063

(22) Filed: Oct. 2, 2009

Related U.S. Application Data
(60) Provisional application No. 61/102,266, filed on Oct. 2, 2008.

(51) Int. Cl. H04J 14/00

(52) U.S. Cl. 398/48; 398/45

(57) ABSTRACT

An optical switch system for dropping a ROADM node is presented. The switch system includes an N×M structure having two layers. A first layer includes optical splitters, each splitter receiving a multiplexed input signal and outputting a first multiplexed output signal. A second layer includes switches receiving the first multiplexed output signals from the optical splitters and generating a second multiplexed output signal. The second multiplexed output signal is typically one of the first multiplexed output signals. An optional third layer, which includes optical filters, receives the second multiplexed output signal from the switches and produces a non-multiplexed, single-wavelength output signal.

### FIELD OF INVENTION

The present invention relates generally to optical communication systems and more specifically to optical systems with reconfigurable optical add/drop multiplexers.

### BACKGROUND

Reconfigurable optical add-drop multiplexers (ROADMs) are a form of optical add-drop multiplexer that adds the ability to remotely and dynamically switch traffic from a wavelength-division multiplexed (WDM) system at the wavelength layer. ROADMs have a multitude of uses in optical systems. For example, ROADMs may be useful in the field of WDM light wave systems for selective broadcasting, dropping, and monitoring of discrete wavelengths. More specifically, ROADMs allow individual wavelengths carrying data channels to be added and dropped from a fiber without the need to convert the signals on all of the WDM channels to electronic signals and back again to optical signals.

The flexibility of current ROADM systems is limited because the Drop end is not really directionless, colorless and contentionless. For example, ROADM cannot be configured to freely drop any wavelength from any input ports. A method and apparatus that would allow this type of configuring is desired.

### SUMMARY

In one aspect, the invention is an N×M optical switching system that includes N number of 1×M optical splitters and M number of N×1 switches. Each of the 1×M optical splitters receives an input signal, which is multiplexed, and outputs a plurality of first multiplexed output signal. The N×1 switches receive the first multiplexed output signals from the optical splitters and generate a second multiplexed output signal, wherein the second multiplexed output signal is one of the first multiplexed output signals.

In another aspect, the invention includes a K×(N×M) switch that includes 1×K tunable splitters that pre-split an input signal before it feeds the split input signal to the N×M switching system above.

In yet another aspect, the invention includes a method of switching optical systems by receiving N optical input signals that are multiplexed, and splitting each of the N optical input signals into M first multiplexed output signals having the same wavelengths as the optical input signals to generate N×M number of first multiplexed output signals. The first multiplexed output signals are fed into M optical switches, each of which selects one of the received multiplexed output signals to generate second multiplexed output signals. Optionally, wavelengths may be selectively dropped from the second multiplexed output signals, resulting in demultiplexed output signals of desired wavelengths.

### DESCRIPTION OF THE DRAWINGS

FIG. 1A illustrates an embodiment of a 4×8 Switch Structure capable of producing single-wavelength output signals.

FIG. 1B illustrates another embodiment of a 4×8 Switch Structure that produces multiplexed output signals.

FIG. 2 illustrates wavelengths entering and exiting one of the Tunable Splitters in the 4×8 Switch Structure of FIG. 1A.

FIG. 3 illustrates the function of an Optical Switch in the 4×8 Switch Structure of FIG. 1A.

FIG. 4 illustrates the function of a Tunable Filter in the 4×8 Switch Structure of FIG. 1A.

FIG. 5 depicts an embodiment of an expanded switch structure incorporating the 4×8 Switch Structure of FIG. 1A.

### DETAILED DESCRIPTION

In the following description, reference is made to the accompanying drawings which illustrate different embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

It will be understood that when an element is referred to as being “on”, “connected to” or “coupled to” another element, it can be directly on, connected or coupled to the other element or intervening elements or layers may be present.

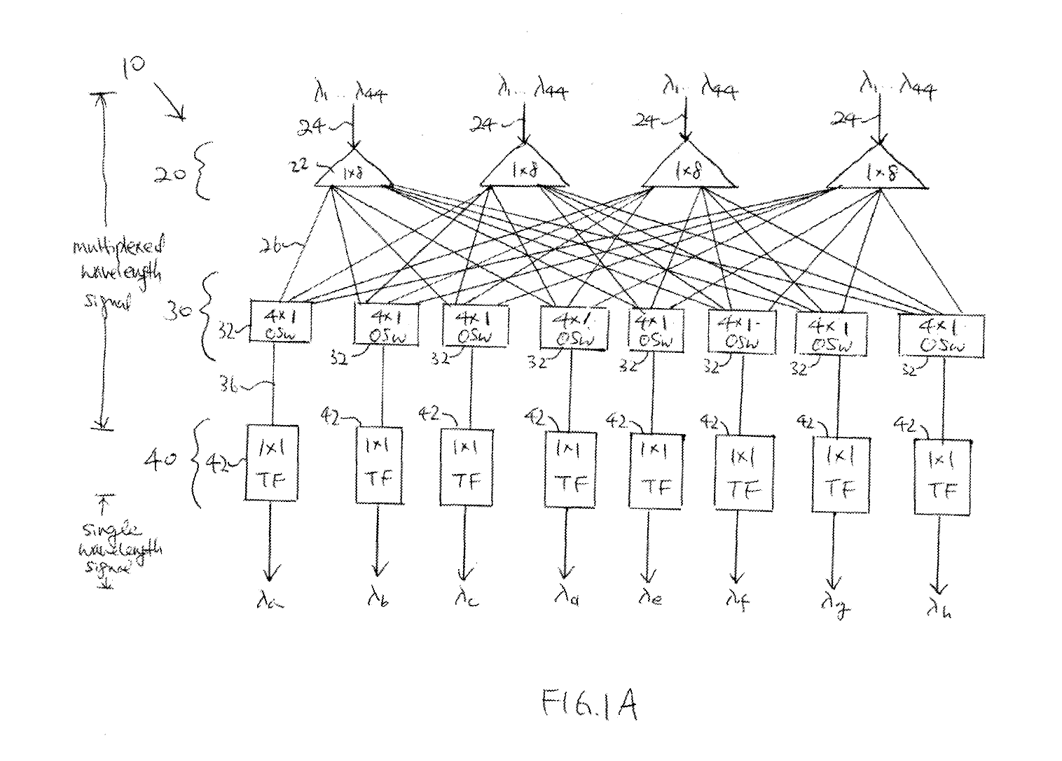

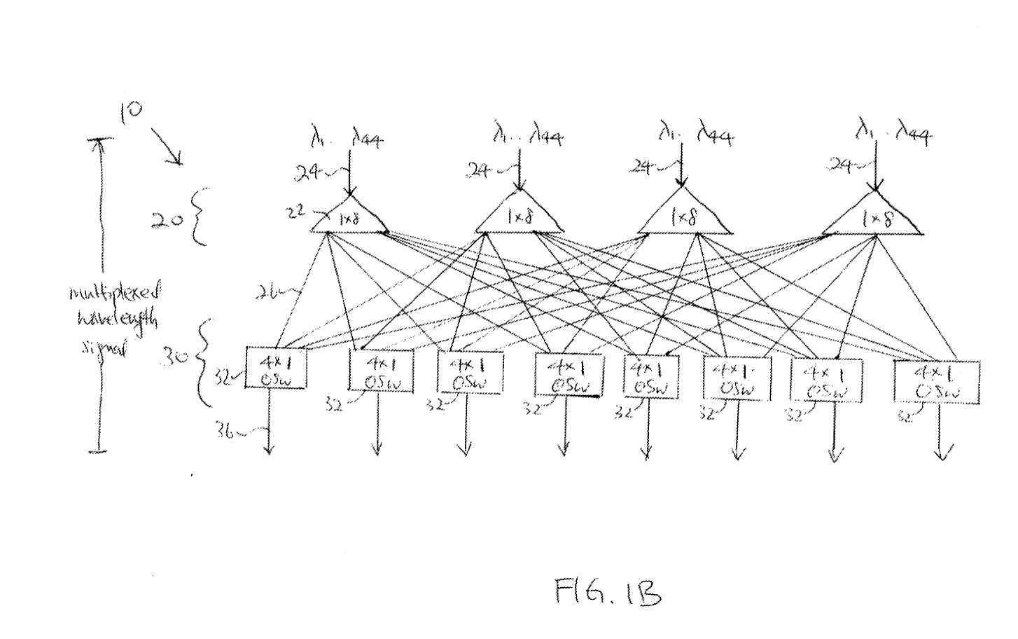

FIG. 1A shows an optical switch system 10 usable for dropping a ROADM node in an optical network. As shown, the optical switch system 10 has an N×M structure where N denotes the number of input ports and M denotes the number of output ports. In the embodiment of FIG. 1A, N=4 and M=8. The switch system 10 has three stages: a first stage 20, a second stage 30, and a third stage 40. The first stage 20 includes N number of 1×M optical splitters 22. Each one of the optical splitters 22 receives a multiplexed input signal 24 and splits the multiplexed input signal 24 into M pieces of multiplexed first output signals 26. The split ratio in the optical splitters 22 can be either fixed or adjustable (tunable). FIG. 2, described below, provides more details about each 1×M splitter 22

Depending on the embodiment, a regular splitter may be used instead of a Tunable Splitter Tsp in the first stage 20. A “tunable splitter,” as used herein, includes splitters that allow control over both the number of output ports and the portion of each output port. No wavelength selection is done by a tunable splitter.

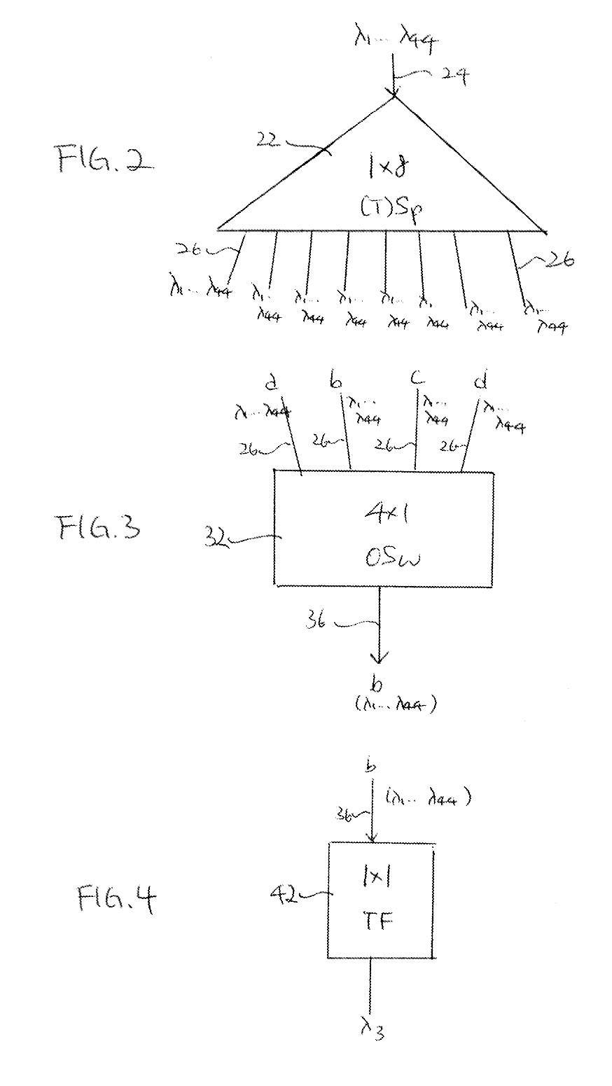

The second stage 30 includes M number of N33 1 switches 32. The switches 32 receive the first output signals 26 that come out of the first stage 20. Each switch 32 selects one of the four incoming signals 26 and forwards it to the third stage 40 as a second output signal 36. Both the signals entering the second stage 30 and exiting the second stage 30 are multiplexed. FIG. 3, described below, provides more details about each N33 1 switch 32.

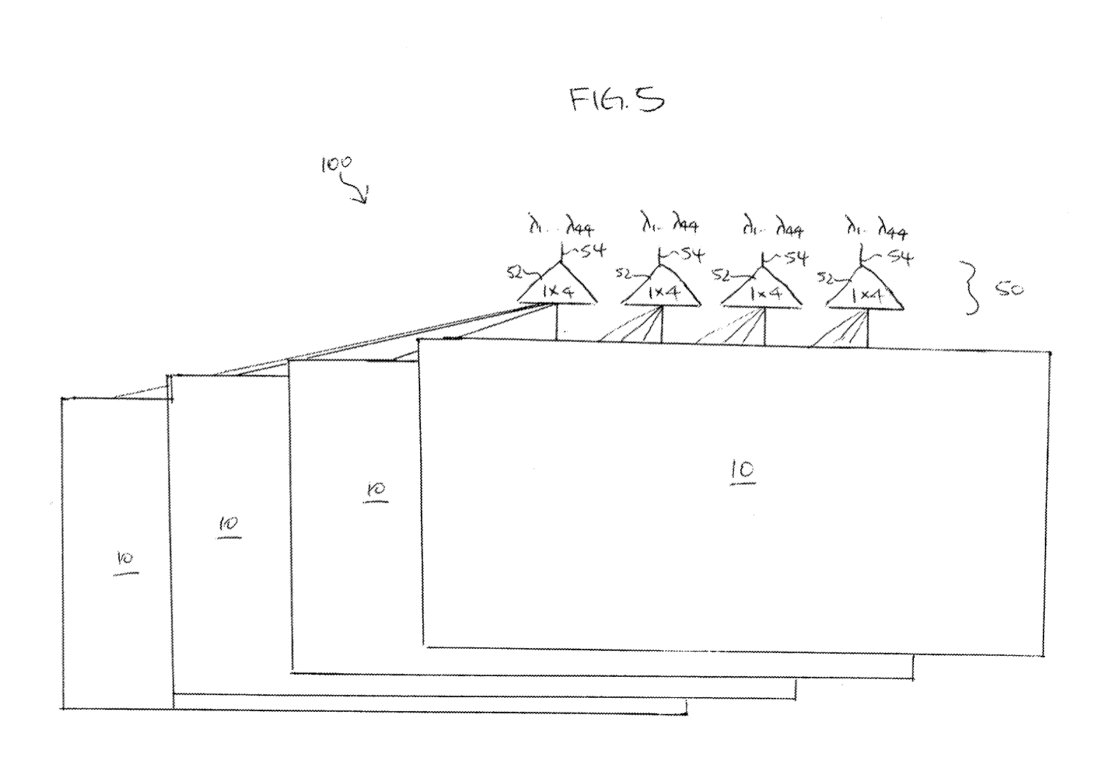

The third stage 40 includes a plurality of optical tunable filters 42. The number of optical tunable filters 42 is the same as that of the N33 1 switches 32. Each tunable filter 42 selects one wavelength from the received second output signal 36 and passes the selected wavelength out of the switch structure 10 in the form of switch structure output signal 46. The optical switch system 10 re-routes or switches multiplexed input signals 24 that are fed into the N input ports into M number of single-wavelength (i.e., not multiplexed) switch structure output signals 46. Different tunable filters 42 may output the same wavelength but these wavelengths originated from different input signals 24. FIG. 4, described below, provides more details about each tunable filter 42.

The invention affords more flexibility to the Drop end of the ROADM system. Any wavelength fed into any input port can be freely selected and dropped to any output port. ROADM nodes in the network will become directionless, colorless and contentionless.

FIG. 1B illustrates another embodiment of a 4×8 Switch Structure. This switch system 10 of FIG. 1B is similar to the embodiment shown in FIG. 1A except that it produces multiplexed output signals. The switch system 10 has the first stage 20 and the second stage 30, but no third stage 40. Hence, this switch structure functions as an N×M switch but does not provide the wavelength selection option like the embodiment of FIG. 1A.

FIG. 2 illustrates wavelengths entering and exiting one of the Tunable Splitters in the 4×8 Switch Structure 10 of FIG. 1A. In the particular example where M=8, the multiplexed signal 24 entering the 1×8 tunable splitter has 44 wavelengths λ₁ through λ₄₄. In many cases, the input signals 24 entering the different tunable splitters in the first stage 20 all carry the same set of wavelengths. However, this is not a limitation of the invention and each port may carry different wavelengths, different number of wavelengths, or a different range of wavelengths as the other input ports. The number of wavelengths entering a single 1×8 splitter 22 is not limited to being 44, and this number could also be 1, i.e., single wavelength signals.

As shown in FIG. 2, there are eight signals 26 exiting the Tunable splitter Tsp. Each of the eight signals 26 contains the same multiplexed wavelengths as the input signal 24 that was fed into the same Tunable splitter Tsp.

FIG. 3 illustrates the function of an Optical Switch in the 4×8 switching system of FIG. 1A. As there are four splitters in the first stage 20, each switch 32 receives four first output signals 26, one from each splitter. Each switch 32 selects one of the four incoming signals 26 (illustrated as signals a, b, c, and d in FIG. 3) and forwards it to the third stage 40 as a second output signal 36. In the example of FIG. 3, signal b is selected. Signal b is a multiplexed signal as no wavelength selection occurs in stage 30.

FIG. 4 illustrates the function of a Tunable Filter in the 4×8 switching system of FIG. 1A. Exiting each Tunable Filter TF is a single wavelength from the multiplexed input signal 24. Where different wavelengths are fed into the multiple tunable splitters Tsp, the output signal exiting one of the Tunable Filters TF may be a wavelength from a multiplexed input signal 24 that was fed into any one of the Tunable Filters TF. The Tunable Filters 24 receive multiplexed signals 36 and generate single-wavelength outputs (e.g., λ₃ in FIG. 4). Prior to reaching the Tunable Filters 24, any one of the four input signals 24 may be redirected to any one of the eight multiplexed wavelength signal paths.

FIG. 5 shows an embodiment of a K×(N×M) optical switch structure 100 that offers even more flexibility to signal routing, and illustrates how the switching system of FIG. 1A can be combined and/or layered to suit an application. The embodiment shown in FIG. 5 is substantially similar to that shown in FIG. 1A, with a primary difference being the addition of a fourth stage 50 before the first stage 20. In the particular embodiment of FIG. 5, K=4, such that there are four switch structures 10. As shown, the fourth stage 50 “ties together” a plurality of switch structures 10. The addition of the fourth stage 50 makes the optical switch structure 100 a K×(N×M) switch structure. The 1×4 splitter TSp is a Tunable Splitter Tsp.

The fourth stage 50 includes a group of 1×4 tunable splitters 52. Each one of the tunable splitters 52 receives an original signal 54 and splits the original signal 54 into up to 4 pieces or branches, depending on the tuning split ratio. If only one N×M switching structure 10 were used, then only one branch of each of the tunable splitters 52 will be set to pass while the others will be blocked to avoid unnecessary splitting. Similarly, if two N×M structures are needed, then two branches of each of the tunable splitters 52 will be set to pass the signals while others will be blocked. The number of N×M structures can keep increasing up to K.

Depending on the application, the system can adjust the number of N×M structure 10 sets needed to be installed. For example, the user can install one N×M structure 10 first. In this case each tunable splitter 52 in the stage 50 will be tuned so that only one branch goes out (i.e., no splitting). Later, as the network grows, the system user may like to add another N×M structure 10. At this point, the user will only need to adjust the tunable splitter 52 to make it pass out 2 branches (i.e., 1×2 splitter), and the addition branch will go to the additional N×M structure 10. The system can keep growing like this up to a plurality (K) of N×M structures 10 together.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. An N×M optical switching system comprising:
N number of 1×M optical splitters that each receives an input signal and outputs a plurality of first multiplexed output signals, wherein the input signal is multiplexed; and
M number of N×1 switches receiving the first multiplexed output signals from the optical splitters and generating a second multiplexed output signal, wherein the second multiplexed output signal is one of the first multiplexed output signals.

2. The N×M optical switching system of claim 1, further comprising optical tunable filters receiving the second multiplexed output signal from the N×1 switches, each of the optical tunable filters passing a preselected wavelength range of the second multiplexed output signals and generating a single-wavelength output signal.

3. The N×M optical switching system of claim 1, wherein each of the 1×M optical splitters receives one input signal and outputs M first multiplexed output signals.

4. The N×M optical switching system of claim 3, wherein each of the M first multiplexed output signals carries the same wavelengths as the input signal.

5. The N×M optical switching system of claim 1, wherein each of the N×1 switches receives N first multiplexed output signals and outputs one second multiplexed output signal.

6. The N×M optical switching system of claim 1, wherein each of the optical tunable filters receives one second multiplexed output signal.

7. The N×M optical switching system of claim 1, wherein each of the N number of 1×M optical splitters receives the same wavelengths.

8. The N×M optical switching system of claim 1, wherein different 1×M optical splitters receive different wavelengths.

9. The N×M optical switching system of claim 1, wherein the optical splitters are tunable.

10. The N×M optical switching system of claim 1, further comprising a layer of 1×K tunable splitters that receive an original signal and generate input signals, such that one of the input signals feeds into one of the 1×M optical splitters.

11. The N×M optical switching system of claim 1, wherein the input signal is a single-wavelength signal.

12. A K×(N×M) switch comprising:
1×K tunable splitters that receive an original signal and generate input signals;
a plurality of N×M switches, each one of the N×M switches receiving one of the input signals and comprising:
N number of 1×M optical splitters that each receives one of the input signals and outputs a first multiplexed output signal, wherein the input signal is multiplexed; and
M number of N×1 switches receiving the first multiplexed output signals from the optical splitters and generating a second multiplexed output signal, wherein the second multiplexed output signal is one of the first multiplexed output signals.

13. The K×(N×M) switch of claim 12, further comprising optical tunable filters receiving the second multiplexed output signal from the N×1 switches, each of the optical tunable filters passing a preselected wavelength range of the second multiplexed output signals and generating a single-wavelength output signal.

14. The K×(N×M) switch of claim 12, wherein each of the 1×M optical splitters receives one input signal and outputs M first multiplexed output signals.

15. The K×(N×M) switch of claim 14, wherein each of the M first multiplexed output signals carries the same wavelengths as the input signal.

16. The K×(N×M) switch of claim 12, wherein each of the N×1 switches receives N first multiplexed output signals and outputs one second multiplexed output signal.

17. The K×(N×M) switch of claim 12, wherein each of the optical tunable filters receives one second multiplexed output signal.

18. The K×(N×M) switch of claim 12, wherein each of the N number of 1×M optical splitters receives the same wavelengths.

19. The K×(N×M) switch of claim 12, wherein different 1×M optical splitters receive different wavelengths.

20. The K×(N×M) switch of claim 12, wherein the optical splitters are tunable.

21. The K×(N×M) switch of claim 12, further comprising a layer of 1×K tunable splitters that receive an original signal and generate input signals, such that one of the input signals feeds into one of the 1×M optical splitters.

22. The K×(N×M) switch of claim 12, wherein the original signal is a single-wavelength signal.

23. A method of switching optical systems, the method comprising:
receiving N optical input signals that are multiplexed;
splitting each of the N optical input signals into M first multiplexed output signals, each of the M first multiplexed output signals having the same wavelengths as the optical input signals, to generate N×M number of first multiplexed output signals; and
feeding the first multiplexed output signals into M optical switches, each of which selects one of the received multiplexed output signals, thereby generating second multiplexed output signals.

24. The method of claim 23, further comprising selectively dropping some of the wavelengths from the second multiplexed output signals to generate demultiplexed output signals of desired wavelengths.

25. The method of claim 23, further comprising:
receiving K original optical signals; and
splitting the K original optical signals into a plurality of optical input signals.

26. The method of claim 23, wherein at least one of the optical input signals is a single-wavelength signal.
